(19) United States
(12) Patent Application Publication
(10) Pub. No.: US 2002/0069099 A1
(43) Pub. Date: Jun. 6, 2002

(54) Test plan review process

(76) Inventors: Theresa M. Knox, Mechanicsville, VA (US); Sharon Robbins, Midlothian, VA (US); Daniel Cash, Midlothian, VA (US)

Correspondence Address: Jennifer A. Albert, Esq., Hunton & Williams, Suite 1200, 1900 K Street, N.W., Washington, DC, 20006, US

(21) Appl. No.: 09/729,353

(22) Filed: Dec. 5, 2000

(51) Int. Cl. G06F 17/60

(52) U.S. Cl. 705/8

(57) ABSTRACT

A test plan review process for verifying a test plan for implementing a request for service is provided. The test plan review process includes the steps of preparing test plan review documents and scheduling a test plan review. The process further includes the steps of identifying and notifying participants of the scheduled test plan review; making the test plan review documents electronically available to the test plan review participants; and conducting the test plan review.

### FIELD OF THE INVENTION

The present invention relates generally to a process for managing change. More particularly, the present invention relates to a process for verifying a test plan or testing conducted in conjunction with the development of a new or a modified product, a new process, or a new service.

### BACKGROUND OF THE INVENTION

Business entities confront change daily. Change may relate to the development of a new product, a new process or a new service (hereinafter, collectively referred to as “new products”) and may include modification of a software application and/or hardware (i.e., “information technology”) employed in such new products. This is particularly true with respect to new financial products which rely increasingly on information technology. Typically, the development of new products involves testing an experimental model or a prototype of a new product prior to commercial production of the new product. A primary objective of this testing is to identify and correct any deficiency in the new product prior to commercial production of the new product.

Many processes exist for managing change and the testing conducted in connection with the development of new products, however, it will be appreciated that more effective and efficient processes are needed.

### SUMMARY OF THE INVENTION

It is an object of the present invention to provide a process for managing change that is effective and efficient.

It is another object of the present invention to provide a process for managing change that can be easily adapted to manage a business and/or a technical change.

It is yet another object of the present invention to provide a process for verifying the testing employed in connection with the development of a new product, particularly a new financial product.

Additional objects and advantages of the invention will be set forth in part in the description which follows, and in part will be obvious from the description, or may be learned by practice of the invention. The objects and advantages of the invention may be realized and attained by means of the instrumentalities and combinations particularly pointed out in the appended claims.

To achieve the objects and in accordance with the purpose of the invention, as embodied and broadly described herein, this invention, in one aspect, includes a test plan review process for verifying a test plan for implementing a request for service, the test plan review process comprising the steps of: (a) preparing a plurality of test plan review documents; (b) scheduling a test plan review; (c) identifying and notifying each of a plurality of participants of the scheduled test plan review, wherein the participants include a facilitator, a test plan author, a technologist, a scribe and a user; (d) making the test plan review documents electronically available to the test plan review participants; (e) conducting the test plan review; (f) receiving any proposed changes to the test plan review documents resulting from the conducted test plan review; (g) recording the proposed changes to the test plan review documents on a test plan review results form; (h) sending the test plan review results form to the facilitator; (i) reviewing the test plan review results form with the test plan author; (j) incorporating the test plan review results from the test plan review results form in the test plan; and (k) filing the test plan review results form.

In another aspect, the invention comprises a request for service (RFS) process comprising the steps of (a) a work management team receiving a request for a service; (b) the work management team forwarding the request for a service to a team of developers; (c) the team of developers recommending at least one change and at least one task to implement the request for a service and forwarding the request for a service together with the recommended at least one change and the at least one task to a change management team; (d) the change management team migrating the request for a service from a development environment to a model office/testing environment; (e) a quality assurance team of the model office writing and implementing a test plan for testing a project which is a subject of the request for a service in the model office/testing environment; (f) if any problems or errors are found during the testing in the test region, the quality assurance team requesting a new task pursuant to a request for a service and forwarding the new task to the team of developers; (g) repeating steps (c) through (f) until there are no errors; (h) the quality assurance team of the model office forwarding the request for a service to the change management team upon successful completion of the testing in the test region and after obtaining business approval; and (i) the change management team implementing the request for a service in a production region.

In yet another aspect, the invention comprises a process for managing change comprising the steps of (a) providing a request for a service (“RFS”); (b) analyzing the RFS by a team of developers; (c) proposing at least one change and at least one task to implement the RFS; (d) testing the proposed at least one change and the proposed at least one task according to a test plan in a test region prior to implementing the RFS in a production region; (e) verifying the testing; and (f) implementing the RFS in the production region.

The accompanying drawings, which are incorporated in and constitute a part of this specification, illustrate embodiments of the invention and, together with the description, serve to explain the principals of the invention.

### BRIEF DESCRIPTION OF THE DRAWINGS

FIG. 1 is a block diagram illustrating the relationship between a plurality of groups of an organization that are responsible for managing a request for a service, according to one embodiment of the present invention.

FIGS. 2A and 2B are block diagrams of a model office work flow of an embodiment of the process of the present invention.

FIG. 3 is a block diagram of the steps conducted during a model office process for managing a request for service internally within an organization.

FIG. 4 is a block diagram illustrating the steps conducted during a model office process for managing a request for service using a facility external to an organization.

FIGS. 5A through 5C are block diagrams illustrating a test plan author's role in a test plan review process according to an embodiment of the present invention.

FIGS. 6A and 6B illustrate a project leader's role in a test plan review process according to an embodiment of the present invention.

FIGS. 7A and 7B illustrate a facilitator's role in a test plan review process according to an embodiment of the present invention.

FIG. 8 illustrates a technologist's role in a test plan review process according to an embodiment of the present invention.

FIG. 9 illustrates a scribe's role in a test plan review process according to an embodiment of the present invention.

FIG. 10 illustrates a user's role in a test plan review process according to an embodiment of the present invention.

FIGS. 11A and 11B are an illustrative test plan template for use in the test plan review process, to conduct the testing, and for use in the test results review process of the present invention.

FIG. 12 is an illustrative test script template for use in the test plan review process, to conduct the testing, and for use in the test results review process of the present invention.

FIG. 13 is an illustrative outline of a test case template for use in the test plan review process, to conduct the testing, and for use in the test results review process.

FIGS. 14A through 14C is an illustrative test plan review checklist for use in the test plan review process.

FIGS. 15A and 15B is an illustrative test script/case review checklist for use in the test plan review process.

FIG. 16 is an illustrative test plan review results form for use in the test plan review process.

FIG. 17 is an illustrative test script/case review results form for use in the test plan review process.

FIG. 18 is an illustrative test plan approval form for use in the test plan review process.

FIG. 19 is an illustrative test results review checklist for use in the test results review process.

### DETAILED DESCRIPTION OF THE PREFERRED EMBODIMENTS

Reference will now be made in detail to the present preferred embodiments of the invention, examples of which are illustrated in the accompanying drawings in which like reference characters refer to corresponding elements.

One aspect of the present invention is directed to a test plan review process. The test plan review process includes preparing a plurality of test plan review documents and scheduling a test plan review. It further includes identifying and notifying each one of a plurality of participants of the scheduled test plan review, making the test plan review documents electronically available to the test plan review participants and conducting the test plan review. Additionally, the test plan review process includes receiving any proposed changes to the test plan review documents resulting from the conducted test plan review; recording the proposed changes to the test plan review documents on a test plan review results form; sending the test plan review results form to the facilitator; reviewing the test plan review results form with the test plan author; incorporating the test plan review results from the test plan review results form in the test plan; and filing the test plan review results form. The test plan review participants may include a test plan author, a facilitator, a technologist, a scribe and a user.

A test plan review is a facilitated meeting for verifying a testing process employed in conjunction with an implementation of a request for a service (“RFS”). The participants review the test plan review documents produced during a model office process in a structured and systematic manner. The test plan review documents may include a test plan, a plurality of test scripts, and a plurality of test cases. Preferably, the test plan review documents are prepared by the test plan author using a plurality of test plan document templates. The test plan review and any follow-up actions are also documented using one or more additional forms. Preferably, all of the forms and test plan document templates used for the test plan review are electronically available in one or more public folders or via a company's intranet.

Typically, the test plan review is led by the facilitator who may also serve as a lead reviewer. The scribe may also be present to record any results of the test plan review and transmit the results to the author and the facilitator after a conclusion of the test plan review. Preferably, the author of the test plan review documents is also a participant in the test plan review. Additional personnel, preferably personnel who are familiar with the subject matter of the RFS, may also participate as reviewers during the test plan review. Preferably, the test plan review participants are company personnel from a test plan review site. A designated change management team is responsible for implementation of the project specified in the RFS.

The primary objective of the test plan review is to determine whether a plurality of conditions are included in the test plan to sufficiently test the functionality of a new product, process, or service, or a modified product, process or service to validate the operation of the new or modified product, process or service in a production environment. If the results of the test plan review indicate that modifications to the test plan are needed, then a revised test plan is developed. If the needed modifications to the test plan are of a minor nature, the test plan may be conditionally approved without a further test plan review, contingent upon satisfactory implementation of the needed modifications agreed upon in the first test plan review. If the needed modifications to the test plan are major, an additional test plan review may be required in order to approve the test plan. The members of the test plan review team determine whether the test plan is conditionally approved. This information is recorded on the test plan results review form.

Preferably, the facilitator is an independent party, i.e., someone who is not part of a development team or a model office team that created the test plan. Preferably, the facilitator ensures that the test plan author provides copies of all of the test plan review documents to the test plan review participants at least 24 hours before the scheduled test plan review. The facilitator and all of the test plan review participants are expected to complete a test plan review checklist before the scheduled test plan review.

Preferably, the facilitator leads the test plan review by going through the test plan review checklist, providing his or her own comments, and soliciting any comments from the other participants in the test plan review. At the end of each section of the test plan review checklist, the facilitator may ask the test plan review participants if there are any questions or comments on that section. If any of the test plan review participants or the facilitator has a proposed change to a test plan review document under review, the facilitator summarizes and restates the proposed change to ensure an agreement among all of the test plan review participants and to ensure that the scribe has accurately documented the proposed change on a test plan review results form and on a test script/case review results form. Typically, after a conclusion of the test plan review the facilitator is responsible for conducting a final review of any proposed changes made to the test plan review documents.

Preferably, the test plan author updates the test plan review documents by making the proposed changes that were agreed upon during the test plan review and documented on the test plan review results form and on the test script/case review results form. The test plan author executes the test plan review results form and the test script/case review results form indicating the action taken and the date the changes to the test plan review documents were made and sends the completed test plan review results form, the test script/case review results form and the updated test plan review documents to the facilitator. The facilitator may make a final review of the updated test plan review documents to verify that the proposed changes were made and also executes the test plan review results form and the test script/case review results form to document completion of final review. The facilitator then preferably sends one copy of the test plan review results form and the test script/case review results form back to the test plan author and a second copy to the project leader for final approval and for filing with the model office.

Typically, the scribe is responsible for recording a plurality of changes agreed upon in the test plan review and is someone who is familiar with a technology that is a subject of the RFS under review in the test plan review. For example, if the RFS involves information technology, the scribe should be familiar with basic terminology used in connection with information technology. Typically, any proposed changes to the test plan review documents suggested during the test plan review, are documented in a plurality of test plan review results forms and a plurality of test scripts/cases review results forms. Preferably, within 48 hours after completion of the test plan review, the scribe documents any proposed changes on the test plan review results form and on the test script/case review results form. The scribe may send the test plan review results form and the test script/case review results form to the test plan author so that the test plan author can update the test plan review documents to reflect the proposed changes agreed upon in the test plan review. Also, the scribe may send the test plan review results form and the test script/case review results form to the facilitator so that the facilitator can confirm with the test plan author that the changes have been made. Alternatively, the scribe may make the proposed changes to copies of the test plan review documents on-line, using, for example, a change tracking feature of a word processing program, such as a Microsoft Word™ word processing program. Preferably, the copies of the test plan review documents are identified by having a word such as “changes” appended to a file name where such test plan review documents are stored in memory in a computer. The original test plan review documents and the copies are routed to the test plan author who creates revised test plan review documents with the proposed changes incorporated therein. These revised test plan review documents may be identified by appending a word such as “final” to a file name where such test plan review documents are stored in memory in a computer. The test plan author may forward all three versions of the test plan review documents to the facilitator for a final review. Preferably, the test plan author may provide an executed copy of the final test plan review documents, the executed test plan review results form and the executed test script/case review results form to record his or her responsibility for the proposed changes.

The test plan author participates in the test plan review, primarily to answer any questions about the test plan review documents. Some of the questions may result in a plurality of changes to the test plan review documents. Typically, after the completion of the test plan review, the test plan author receives the test plan review results form and the test script/case review results form and makes any proposed changes to the test plan review documents as specified on the test plan review results form and the test script/case review results form. Preferably, the test plan author may initial each change in the test plan review results form and in the test script/case review results form.

Once the proposed changes are made to the test plan review documents, the test plan author may forward the updated, revised test plan review documents to the facilitator along with the signed test plan review results form and the signed test script/case review results form. After the facilitator has performed a final review and approved the test plan review results form and the test script/case review results form as indicated by his or her signature, a copy of the test plan review results form and the test script/case review results form is sent back to the test plan author and to the project leader.

Preferably, the official approval of the test plan is documented on a test plan approval form. Typically, the project leader is responsible for obtaining any necessary approvals and forwarding an executed copy of the test plan approval form to the model office. Typically, the project leader is responsible for scheduling the test plan review. The project leader also may be responsible for identifying the test plan review participants that are not part of the development team or the model office team that created the test plan review documents, scheduling one or more conference calls with such test plan review participants, and providing a conference room for the conduct of the test plan review at the site of the test plan review. The project leader also may ensure that all test plan review checklists are completed and executed, and that the completed test plan review results form and the completed test scripts/cases review results form are sent to any proper people and places.

Preferably, a user participant is someone from the site where the test plan was written, who is familiar with the business functionality of the RFS which is the subject of the test plan review. The user typically completes a plurality of test plan review checklists before the scheduled test plan review and may use the completed test plan review checklists to ask a plurality of questions during the scheduled test plan review. The user may also make a plurality of suggestions for changes in the test plan review documents under review.

A technologist is someone who is familiar with the technology of the RFS which is the subject of the test plan review. For example, if the technology being reviewed is information technology, the technologist is an information technology expert. Typically, the technologist has similar responsibilities as the user during the test plan review.

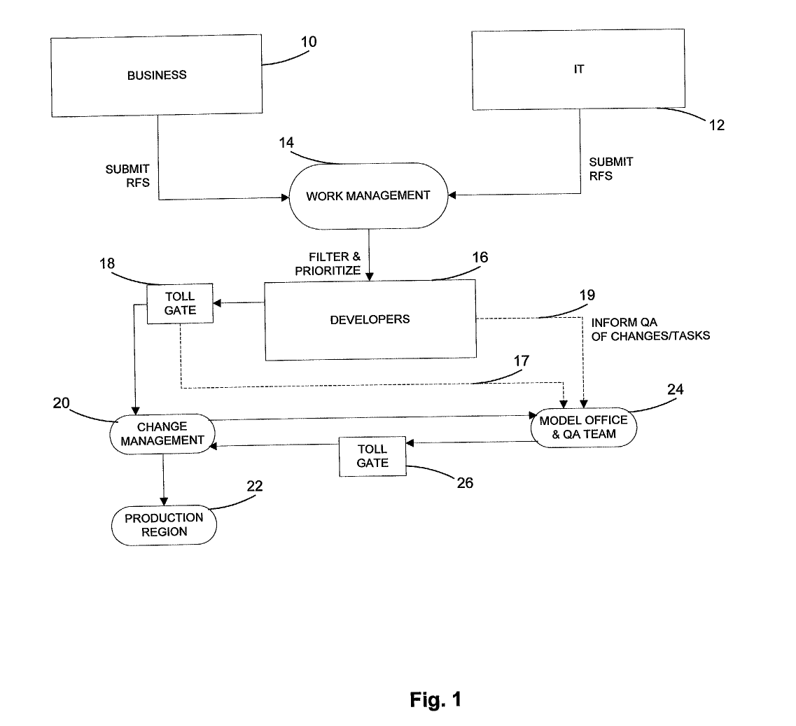

FIG. 1 provides a high level overview showing a plurality of groups, offices or units responsible for handling an Request for Service (RFS) within a company. A business unit 10 or an information technology unit 12 may submit an RFS to a work management team 14. An RFS is not limited to any particular product or service but may involve any request for implementation of any new product, process or service, or for implementation of a modification to an existing product, process or service. The RFS may also relate to a item of equipment or a system used within a company. An RFS can be any request for a modification or improvement to any business function within the company. As will be understood, the processes of the present invention are applicable to numerous products, processes, services and activities within the company. The work management team 14 is a group designated to receive all RFS's within the company. The work management team 14 records the RFS in a centralized database. The business unit 10 and the developers 16 prioritize the submitted RFSs. The work management team 14 forwards each RFS to one or more developers 16 and to any other persons or entities who are needed to perform tasks relating to the RFS. The developers 16 are responsible for implementation of a project pursuant to a submitted RFS. An organization may have more than one group of developers 16 wherein each group of developers 16 is responsible for handling a specific product, process or service area. Thus, typically the work management team 14 will forward an RFS to an appropriate group of developers 16 depending upon the subject matter of the RFS. The developers 16 will prioritize the submitted RFSs with the business unit 10 to determine an order in which the submitted RFSs will be implemented.

The developers 16 implement a project pursuant to the RFS in a test region and conduct a plurality of preliminary tests to ensure that the implementation work was properly done before submission to the model office 24 for testing. For example, if the RFS involves a request for a change in a software code, the developers 16 may propose one or more changes to the software code in issue, make such proposed changes to a prototype copy of the software code, and test such proposed changes by conducting one or more computer simulations of the software code with such proposed changes. A tollgate 18 is provided at a stage in the process where the developers 16 should inform the model office 24 of the changes and/or tasks to be implemented and the model office 24 should verify the completeness of the developers' 16 tests. Preferably, the developers 16 forward the RFS together with the recommended changes and tasks to a change management team 20 which forwards the RFS to the model office 24 test region and notifies the model office 24 that the RFS is ready to test.

The role of the change management team 20 is to migrate tasks, modifications and/or changes relating to work performed pursuant to an RFS from a development environment to a model office or test environment. After model office testing is completed and the person(s) who originally submitted the RFS has approved the results of the model office testing, the change management team 20 migrates such tested tasks, modifications and/or changes from the model office/testing environment to the production environment.

The model office 24 is comprised of a quality assurance team (“QA”) which is a group of employees who are responsible for writing and implementing a test plan. The test region is an environment which emulates a production or commercial environment in which the project that is the subject of the RFS will be finally implemented. If any problems or errors are found during the testing in the test region, a new task is requested by the quality assurance team pursuant to an RFS which is then given to the developers 16 as indicated by broken lines 17 and 19 in FIG. 1. Upon successful completion of the testing, the quality assurance team forwards the RFS to tollgate 26 for business approval. After business approval, the RFS is sent back to a change management team 20 for implementation in the production region 22. The change management team 20 notifies all of the appropriate businesses and developers that the project has been moved to the production region 22.

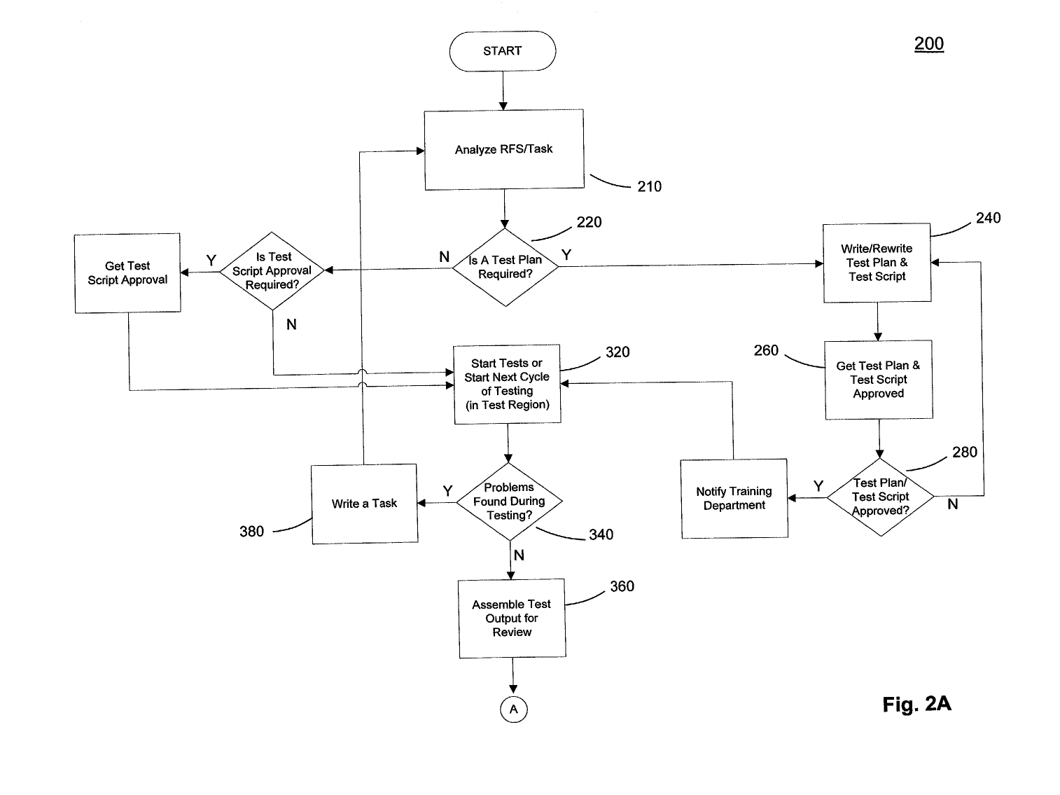

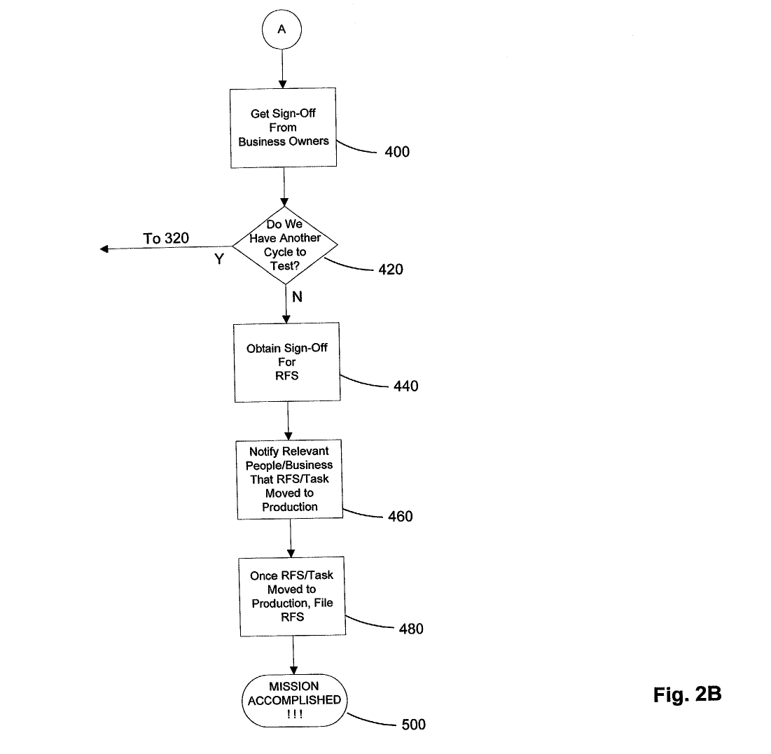

FIGS. 2A and 2B are block diagrams of a work flow for a process 200 conducted by the model office 24 after an RFS is received from the change management team 20 according to an embodiment of the invention. In step 210, the model office 24 receives an RFS, analyzes the RFS with the associated changes and tasks as received from the developers 16, and determines an appropriate approach for conducting testing relating to each received RFS. In step 220, the model office 24 determines if a test plan is required. If the determination of step 220 is affirmative, the process 200 branches to step 240 wherein the model office 24 writes a test plan and a test script for conducting testing pursuant to the test plan. A test plan preferably includes a definition of one or more scenarios illustrating events that could occur during use of the implemented project in the production environment. A test script may be written for testing the project for each of the scenarios. The test script will define how to emulate the scenario in order to determine how the project reacts to the scenario. The model office 24 obtains any required approvals of the test plan and the test script in step 260. In step 280, the process 200 verifies that the test plan and the test script are approved, and, if so, in step 300, the model office 24 starts a next cycle of testing in the model region in step 320.

In step 340, the training department is notified of changes implemented pursuant to RFSs which may affect business processes so that a training plan can be developed to train employees on such changed business processes. If no problems occur in step 340, the process 200 then branches to step 360 where the model office 24 assembles the results of the testing conducted for further review. If, in step 340, there are problems, a new task is written by the model office 24 which is then given to developers 16. The new task undergoes the same process 200 starting with step 210.

After assembling the results of the testing conducted for further review, the model office 24 submits the results of the testing to the persons who had submitted the RFS (i.e., the “business owners”) in step 400. In step 420, the business owners make a determination whether more testing is needed prior to an approval and, if more testing is needed, the process 200 returns to step 320 to start another cycle of testing in the test region. When the testing is finally completed, the model office 24 obtains approval of the person(s) who originally submitted the RFS in step 440. The model office 24 submits the project that is subject to the RFS to the change management team 20 for installation to the production region in step 460. Once the project subject to the RFS is moved to the production region, the RFS is closed indicating its completion in step 480.

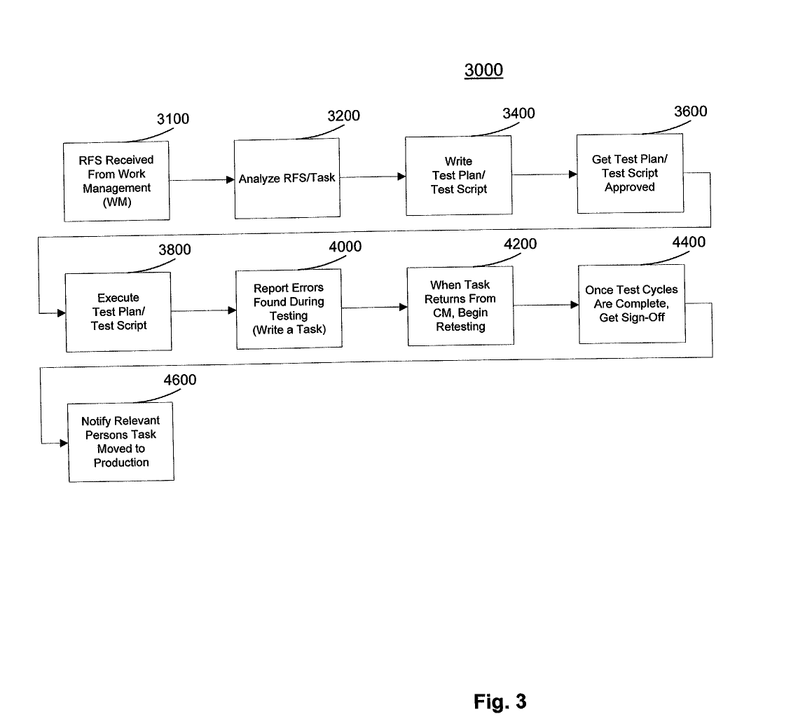

FIG. 3 is a process flow diagram illustrating a process 3000 for managing an RFS internally within a company according to an embodiment of the invention. In step 3100, the model office 24 receives an RFS from the work management team 14. In step 3200, the model office 24 analyzes the received RFS, and determines an approach for testing each task. In step 3400, the model office 24 then writes a test plan and/or a test script and, in step 3600, the model office 24 approves the test plan and/or the test script, conducts the testing pursuant to the test plan and/or the test script in step 3800, and, in step 4000, reports any errors found during the testing. Also in step 4000, the model office 24 then writes a task for fixing the errors. The task is preferably forwarded to the work management team 14.

In step 4200, when the task comes back to the model office 24 from the change management team 20, the model office 24 begins testing the task. Once all of the test cycles are complete, in step 4400, the model office 24 obtains an approval from the person(s) who originally submitted the RFS. In step 4600, the model office 24 also notifies all of the test plan review participants that the project has moved to the production region.

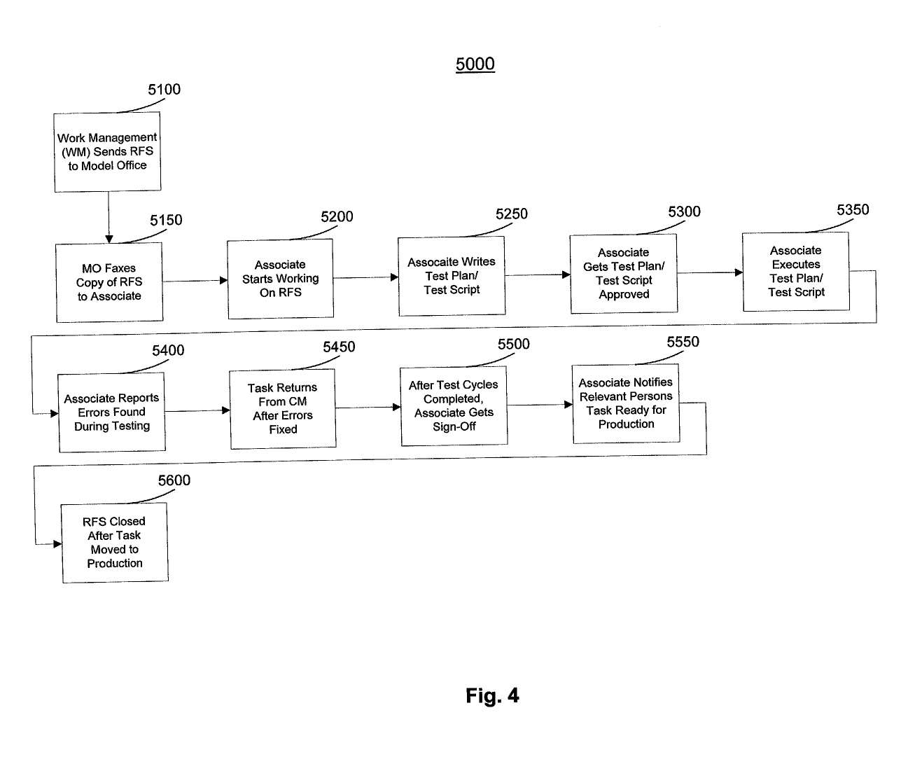

FIG. 4 is a process flow diagram illustrating a process 5000 for managing an RFS using a facility external to the company. As shown in FIG. 4, the process 5000 begins with step 5100 in which the work management team 14 sends an RFS to the model office 24. In step 5150, an analyst in the model office 24 transmits a copy of the RFS to the external facility, such as via use of a facsimile machine or via email, for example. In step 5200, an associate at the external facility is assigned to the RFS and starts working on the RFS. The associate at the external facility writes a test plan and/or a test script in step 5250 and then obtains approval of the written test plan and/or test script in step 5300. The associate then executes the written test plan and the written test script in step 5350, conducts testing pursuant to the test plan and/or the test script and reports any errors found during testing by writing a task in step 5400. In step 5450, the task is sent to the change management team 20 after the errors found during testing are fixed by the developers 16. Once all of the test cycles are completed, the associate obtains an approval from person(s) who originally submitted the RFS in step 5500. Preferably, a test results review is conducted prior to moving the project that is the subject of the RFS to the production region. In step 5550, the associate notifies all of the relevant persons that the project which is the subject of the RFS has moved to the production region. In step 5600, the RFS is closed after it is moved to the production region.

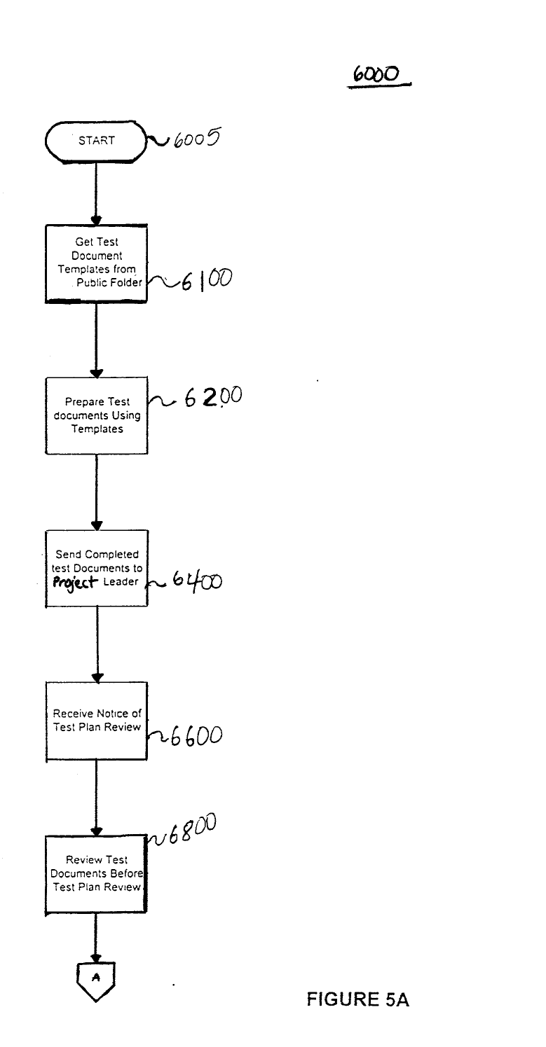

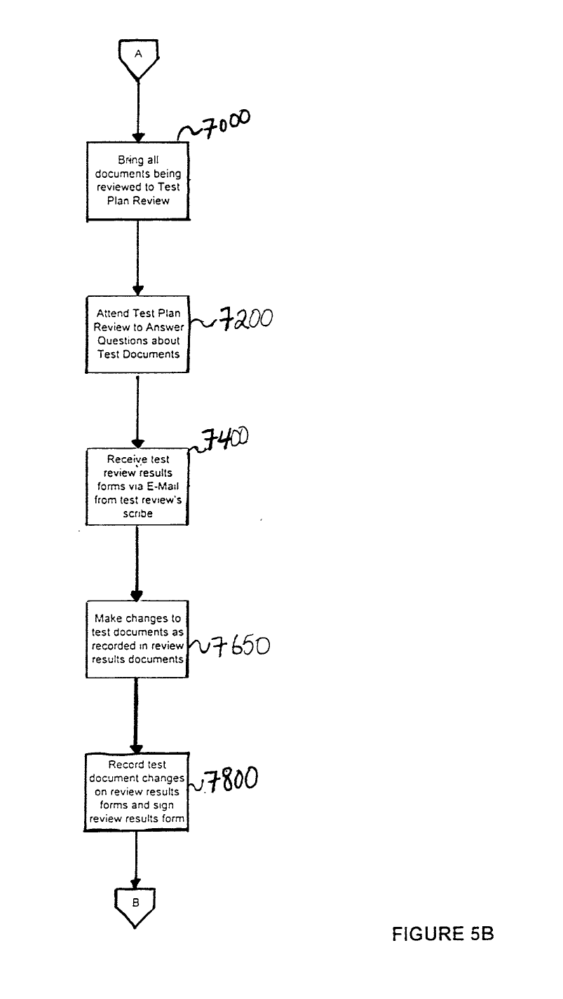

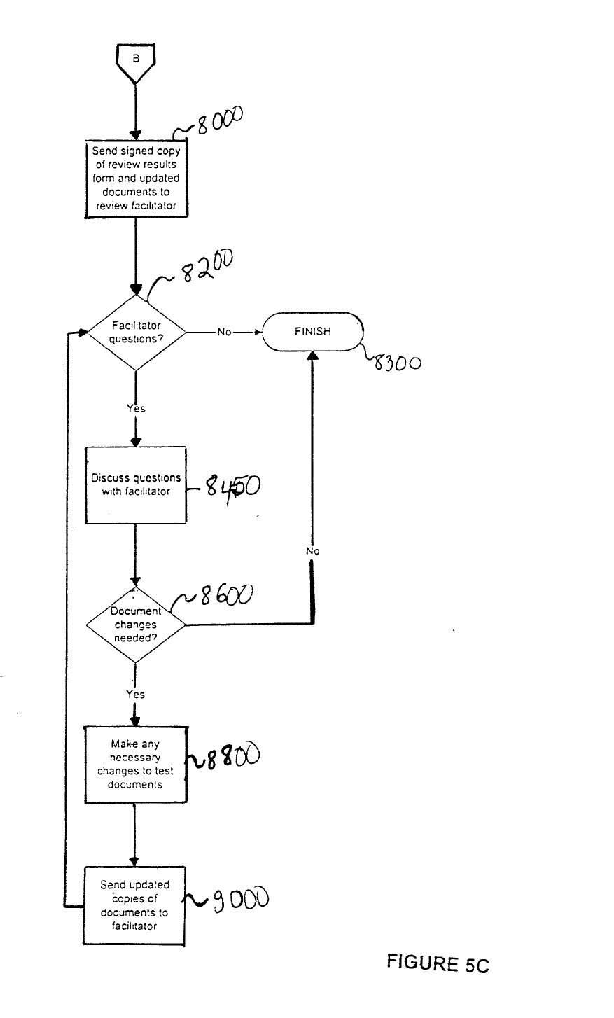

FIGS. 5 through 10 illustrate the roles played by each of the participants in the test plan review process. FIGS. 5A through 5C illustrate the test plan author's role in the test plan review process and the various activities conducted by the test plan author. The test plan review process 6000 begins at step 6005 with the drafting of the test plan review documents by the test plan author. At step 6100, the test plan author may access a plurality of test plan document templates from a project public folder saved in a memory of an organization's computer network. In step 6200, the test plan author then prepares the test plan review documents using the test plan document templates. In step 6400, the test plan author sends the completed test plan review documents to the project leader. Preferably, the documents are sent electronically by the test plan author via email to the project leader. The project leader may file the test plan review documents in the project public folder or a site-specific subfolder of the project public folder. Preferably, the initial version of the test plan review documents that are saved to the project public folder will have a “draft” designation appended to an end of a file name. In step 6600, the test plan author receives a notice of a scheduled test plan review preferably via email from the project leader responsible for the RFS. In step 6800, the test plan author reviews the draft test plan review documents before the scheduled test plan review. Preferably, the test plan author retrieves a test plan checklist and a test script/case checklist from the project public folder, and retains the checklists for reference during the test plan review. In step 7000, the test plan author brings all of the test plan review documents to the scheduled test plan review. For example, the test plan author can retrieve the test plan review documents from the project public folder, or from the site-specific subfolder and can then print out hard copies of the test plan review documents to be reviewed during the test plan review. In step 7200, the test plan author attends the scheduled test plan review to answer one or more questions from the test plan review participants about the test plan review documents. In step 7400, the test plan author receives the test plan review results form and the test script/case review results form via email from the scribe. Preferably, the test plan review results form and the test script/case review results form are available within 48 hours after the conclusion of the test plan review. In step 7650, the test plan author makes any necessary changes to the test plan review documents as recorded in the test plan review results form and the test script/case review results form. In step 7800, the test plan author records the necessary changes on the test plan review results form and on the test script/case review results form and executes the test plan review results form and the test script/case review results form.

In step 8000 (shown in FIG. 5C), the test plan author sends the executed copy of the test plan review results form and the test script/case review results form and the updated, revised test plan review documents reflecting the necessary changes to the facilitator. Preferably, the executed test plan review results form and the test script/case review results form should be sent to the facilitator via interoffice mail or by facsimile. The facilitator reviews the revised test plan review documents sent by the test plan author and makes a determination as to whether he has any questions about such revised test plan review documents in step 8200. If the facilitator does not have any questions, the role of the test plan author in the test plan review is finished in step 8300. If the facilitator has questions in step 8200, then the process 6000 proceeds to step 8450 where the facilitator discusses the questions with the test plan author. In step 8600, a determination is made as to whether any changes are needed to the test plan review documents to clarify the test plan review documents based on the facilitator's questions. If changes are needed, then the process 6000 proceeds to step 8800 where the test plan author makes the necessary changes to the test plan review documents. If, in step 8600, a determination is made that there are no changes needed, the process 6000 branches to step 8300 where the role of the test plan author in the test plan review process is finished. In step 9000, the test plan author sends updated, revised copies of the test plan review documents reflecting the necessary changes to the facilitator for a further review.

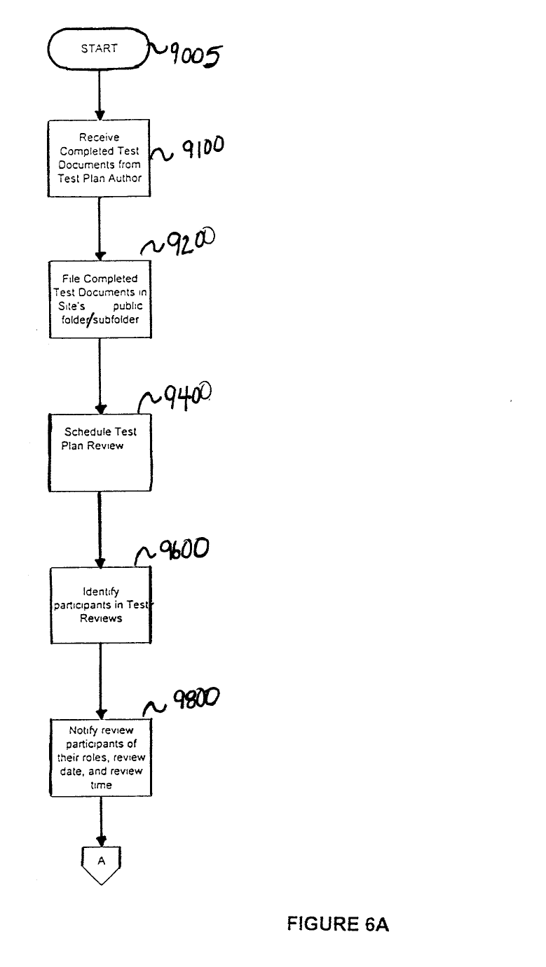

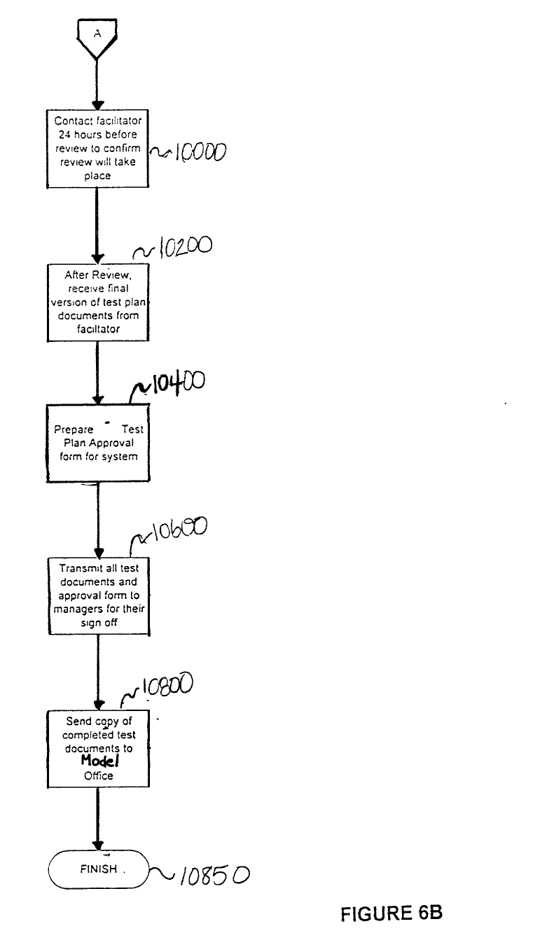

Referring to FIGS. 6A and 6B, the role of the project leader is shown. In step 9100, the project leader receives the completed test plan review documents from the test plan author. The project leader files the completed test plan review documents in the project public folder or in the site-specific subfolder in step 9200. The project leader then schedules a test plan review for the system subject to the RFS. The project leader may meet with one or more counterpart project leaders participating in similar test plan reviews and may schedule a single test plan review for all of the RFS changes. A test plan review schedule may also be posted in the project public folder, preferably in outlook calendar format. The project leader also identifies one or more test plan review participants for the scheduled test plan review in step 9600. For example, the project leader is responsible for providing a facilitator for the test plan review (also referred to as the “lead reviewer”) and notifying this facilitator of a date and a time for the scheduled test plan review. Preferably, the project leader is also responsible for providing a scribe, a technologist, and a user to participate in the scheduled test plan review.

In step 9800, the project leader notifies the test plan review participants of their roles in the test plan review, and the date and the time for the scheduled test plan review. The test plan review notification may be sent via email together with the test plan review documents to be used in the test plan review, or the project leader may notify the test plan review participants of a link to the project public folders from where the test plan review documents may be retrieved. In step 10000, the project leader also contacts the facilitator at least 24 hours before the scheduled test plan review to confirm that the test plan review will take place. After the completion of the test plan review, in step 10200, the project leader receives a final version of the test plan review documents from the facilitator.

Typically, the test plan review documents are received within five business days following completion of the test plan review. The test plan review documents include the test plan, the test scripts, the test cases, the completed test plan review results form signed by the test plan author and the facilitator, and the test script/case review results form signed by the test plan author and the facilitator. In step 10400, the project leader then prepares a test plan approval form. In step 10600, the project leader transmits all of the test plan review documents and the test plan approval form to the business owners of the system under review for their approval or sign-off. The sign-off may be accomplished by affixing a signature and a date either physically or electronically in a signature block on the test plan approval form. In step 10800, the project leader then sends a copy of the completed test plan review documents to the model office. The completed test plan review documents may include a plurality of completed checklists from the facilitator, a final test plan, final test scripts/cases, a completed test plan review results form, a completed test script/case review results form, and a signed test plan approval form. If completed electronically, the completed checklists can be emailed.

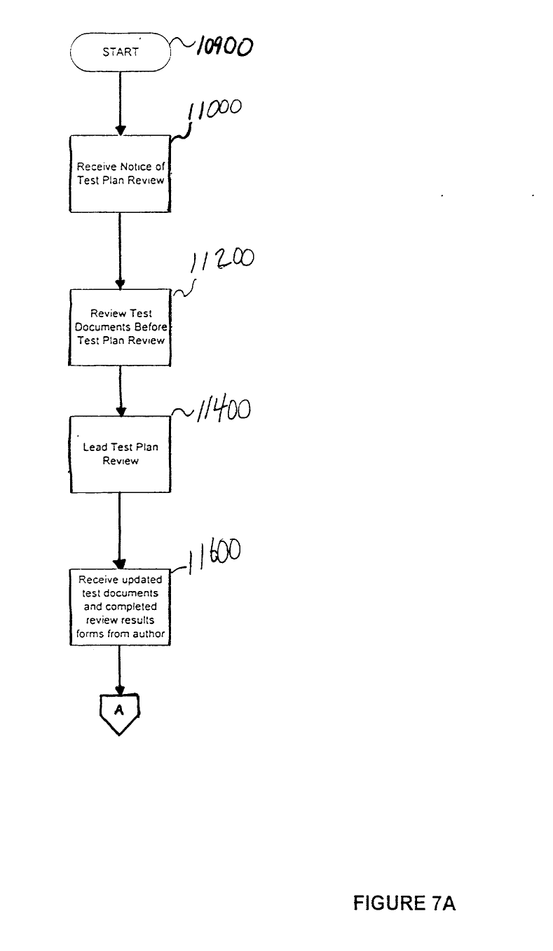

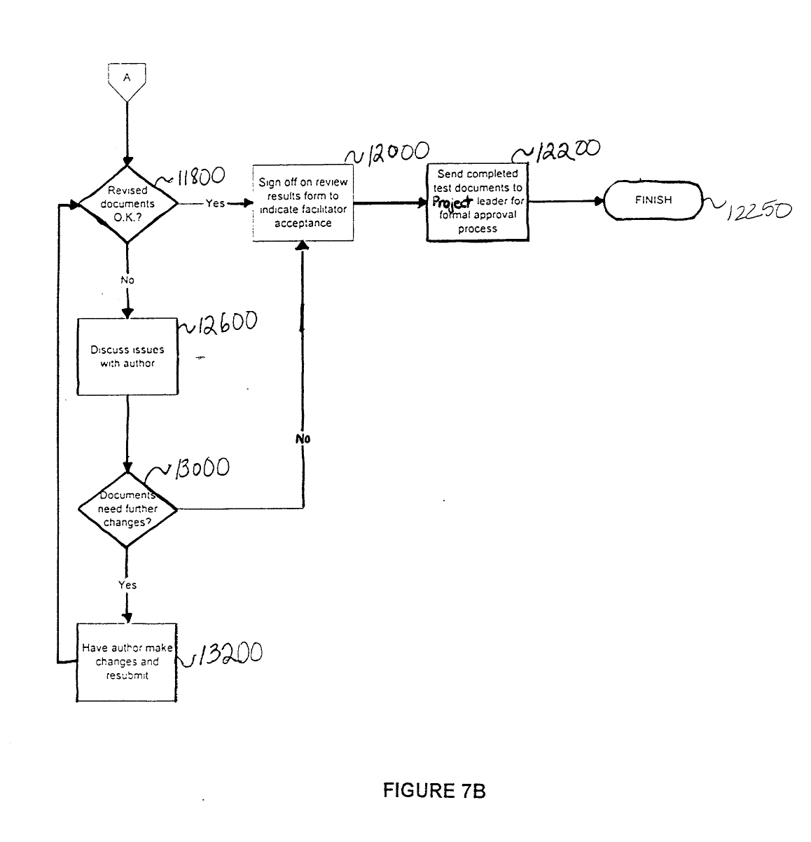

Referring to FIGS. 7A and 7B, the facilitator's role is illustrated. As shown therein, the next part of the process 6000 begins at step 11000 wherein the facilitator receives notice of the scheduled test plan review. This notification is preferably done by email from the project leader. In step 11200, the facilitator reviews the test plan review documents before the scheduled test plan review and completes the test plan review checklist and the test script/case review checklist. Preferably, the facilitator can access the test plan, the test scripts, and the test cases from the site-specific subfolder in the project public folder. The facilitator may also access the test plan review checklist and the test script/case review checklist from the project public folder. Then, in step 11400, the facilitator manages the test plan review. This involves review of each checklist and each test plan review document, review of a representative sample one of the test scripts and test cases, and ensuring that any recommended changes made during the test plan review are clearly stated by a participant so that the scribe can accurately record such recommended changes. In step 11600, the facilitator receives the updated, revised test plan review documents reflecting the recommended changes and the completed test plan review results form from the test plan author. These documents are preferably received by the facilitator within four days following completion of the test plan review. The updated test plan review documents may be transmitted via email, while the test plan review results forms should be delivered manually or by facsimile since they should be signed by the test plan author. In step 11800, the facilitator makes a determination as to whether the updated test plan review documents are found to be in good order. If the determination in step 11800 is affirmative, in step 12000, the facilitator will execute the test plan review results form to indicate facilitator acceptance, and in step 12200, the facilitator will send the completed updated test plan review documents to the project leader for formal approval processing, which step 12200 terminates the facilitator's involvement in the test plan review. If the determination in step 11800 is negative, however, the process 6000 goes to step 12600 where the facilitator discusses any issues he has with the test plan review documents with the test plan author. Subsequent to this discussion with the test plan author, in step 13000, the facilitator makes another determination of whether the test plan review documents require any changes. If the determination in step 13000 is negative, the process 6000 branches to step 12000 where the process 6000 then proceeds as previously described. If the determination step 13000 is affirmative, the process 6000 proceeds to step 13200 where the facilitator requests that the test plan author make additional changes to the test plan review documents and then branches back to step 11800 and proceeds until approval is received.

The test plan review documents include the facilitator's completed checklists, the final test plan/test scripts/test cases, the completed test plan review results form, and the completed test script/case review results form. If the checklist is electronically completed it may be transmitted via email. Preferably, the test plan review results form should be transmitted via facsimile.

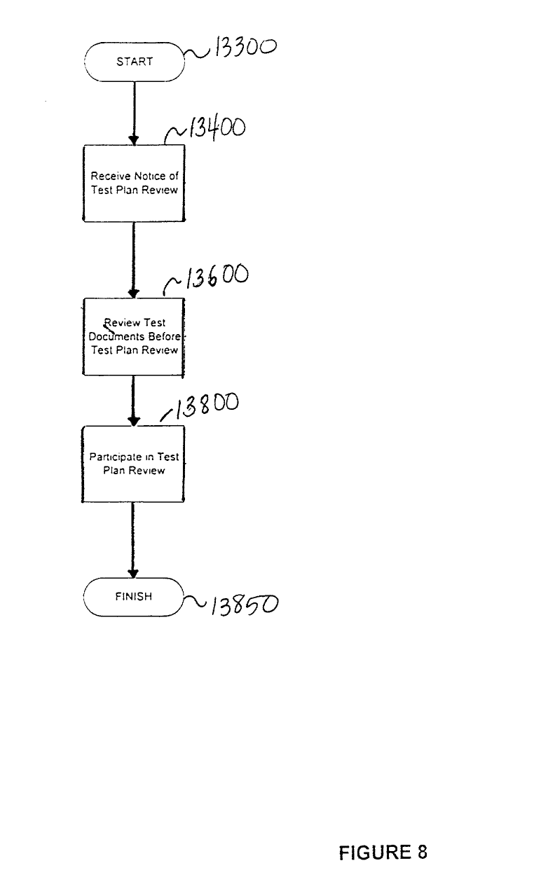

FIG. 8 illustrates the role of the technologist in the test plan review process. Referring to FIG. 8, the technologist receives notice of the scheduled test plan review in step 13400. The notice is preferably transmitted via email from the project leader. In step 13600, the technologist obtains the test plan review documents before the scheduled test plan review. Preferably, at least 24 hours before the scheduled test plan review, the technologist retrieves and reviews the test plan review documents from the site-specific subfolder of the project public folder and completes the test plan review checklist and the test script/case review checklist. In step 13800, the technologist then attends and participates in the test plan review. Specifically, the technologist reviews each checklist and each test plan review document, and ensures that any recommended changes made on his/her part are clearly stated so that the scribe can accurately record such recommended changes. Following step 13800, the technologist's role is finished.

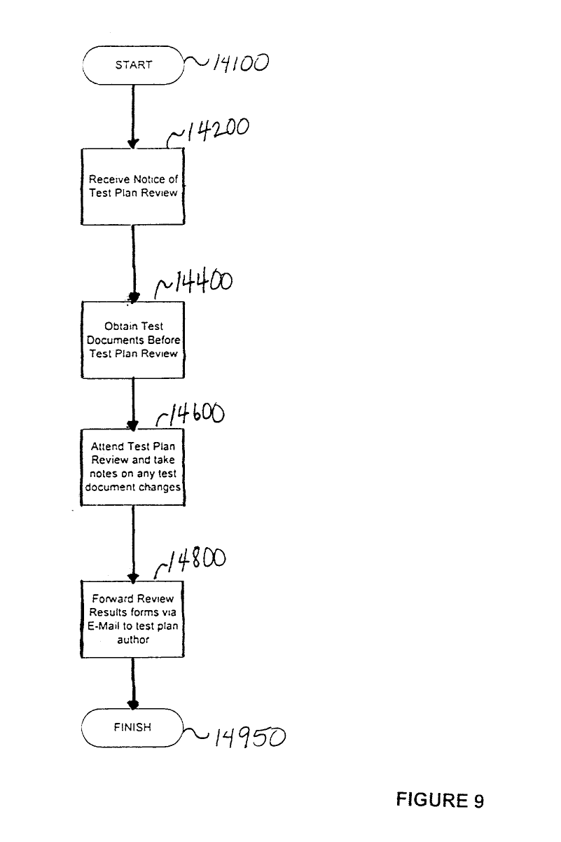

FIG. 9 illustrates the scribe's role in the test plan review process. Referring to FIG. 9, in step 14200, the scribe receives a notice of the scheduled test plan review. The notice is preferably transmitted by email from the project leader. In step 14400, the scribe retrieves the test plan review documents from the site-specific subfolder of the project public folder in the same manner as discussed above and reviews the retrieved test plan review documents before the scheduled test plan review. In step 14600, the scribe attends the test plan review and takes notes documenting any recommended changes to the test plan review documents. The scribe completes the test plan review results form and the test script/case review results form and makes sure that any agreed-upon changes to the plan review test documents are clearly documented. The scribe then forwards the completed test plan review results form and the test script/case review results form via email to the test plan author and the facilitator in step 14800. The results of the test plan review are forwarded, preferably, within two days of completion of the test plan review. Following transmission of the test plan review results form and the test scripts/cases review results form to the test plan author and the facilitator, the scribe's role is finished.

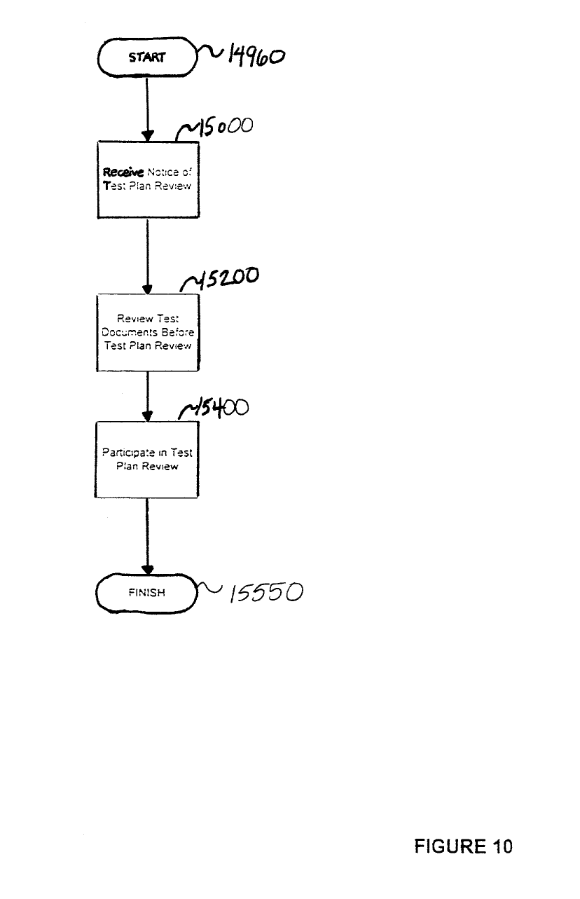

Referring to FIG. 10, in step 15000, the user participant receives notice of the scheduled test plan review. The notice is preferably transmitted via email from the project leader of the location of the system under review. In step 15200, the user then retrieves the test plan review documents in a manner similar to that described above, reviews the retrieved test plan review documents before the scheduled test plan review, and completes the test plan review checklist and the test script/case review checklist. Preferably, the test plan review documents are obtained at least 24 hours before the scheduled test plan review. In step 15400, the user then participates in the test plan review, and reviews each checklist and each test plan review document to ensure that any changes recommended by him/her during the test plan review are clearly stated so that the scribe can accurately record them. Following the test plan review, the user's role is finished.

There are a number of documents and forms completed and used during the test plan review process of the present invention. For example, a test plan review schedule for all scheduled test plan reviews is available in the project public folder. The test plan review schedule may be presented in an Excel spreadsheet format, for example. Any illustrative test plan review schedule for a business application may also be presented in a Microsoft Outlook calendar format.

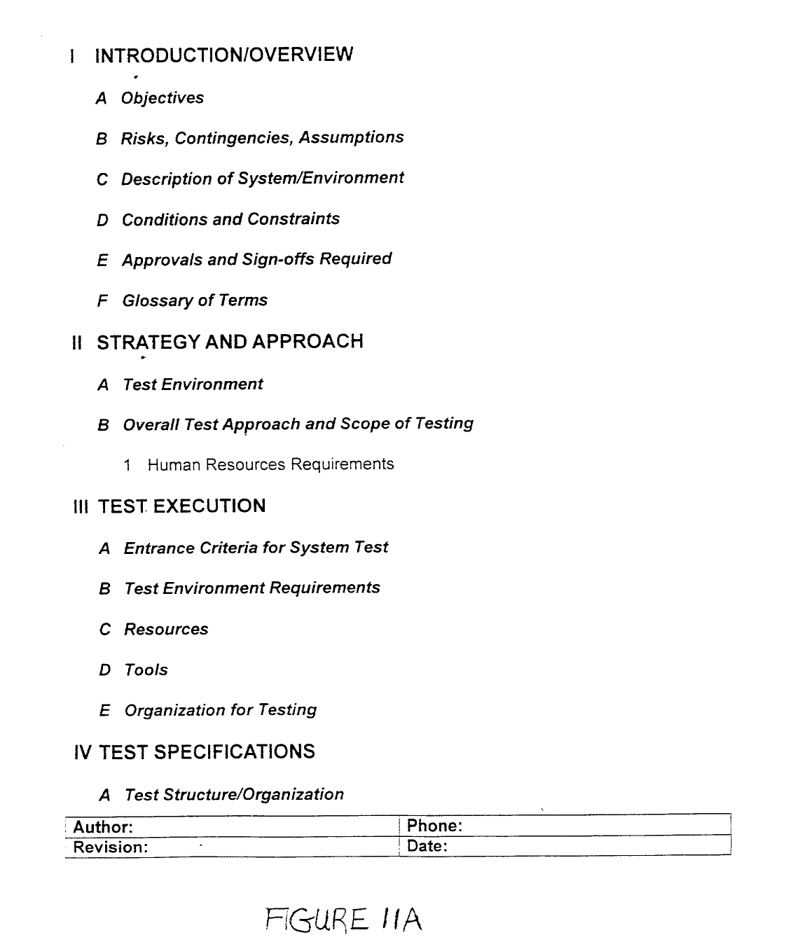

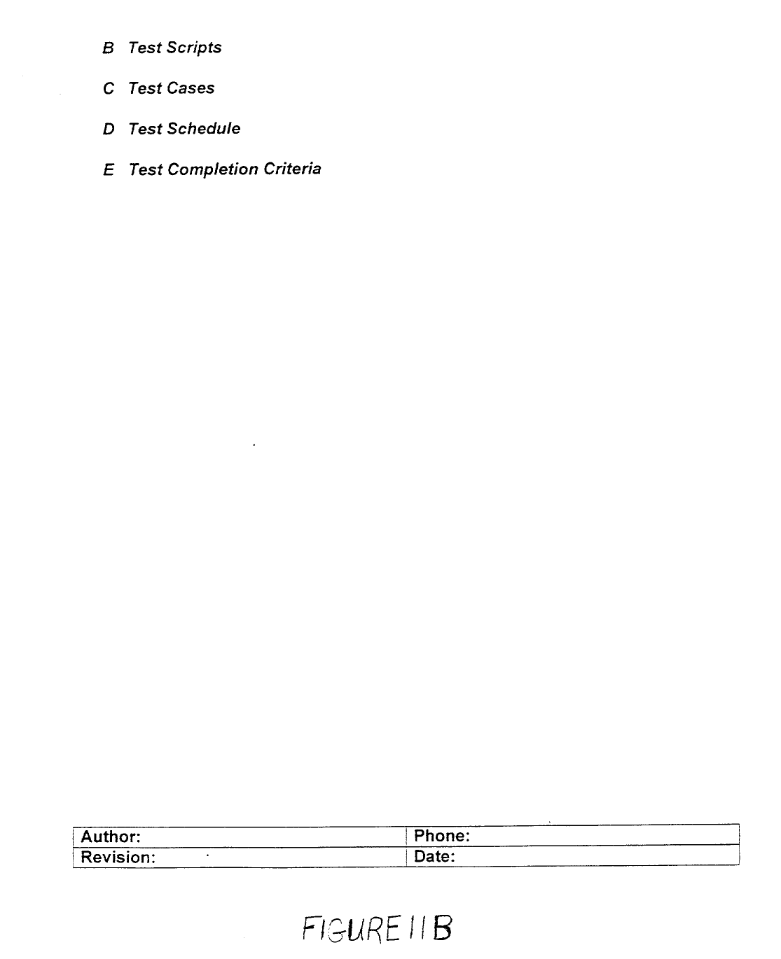

An illustrative example test plan template, used for generating a test plan for testing a project implementation, such as for testing a modification to a computer system, is shown in FIGS. 11A and 11B. There should be at least one test plan for each project pursuant to an RFS. This test plan template includes a plurality of sections, such as, for example, an introduction/overview section wherein one or more objectives of the project are defined. One or more risks, contingencies and/or assumptions in connection with the project may also be set forth. The introduction section may also include a description of the current system, a listing of any required approvals, and a glossary of terms and constraints on the project, such as a budget for the project. The test plan template may also include a strategy and approach section defining the test environment, an overall test approach and a scope of testing. The scope of testing preferably should include a discussion of human resources required to conduct the testing. A third section describing the test execution and a fourth section setting forth test specifications may also be included in the test plan template. With the test specifications section, the completed test plan should include the test scripts, the test cases, a schedule for the testing and criteria to use to determine completion of the testing.

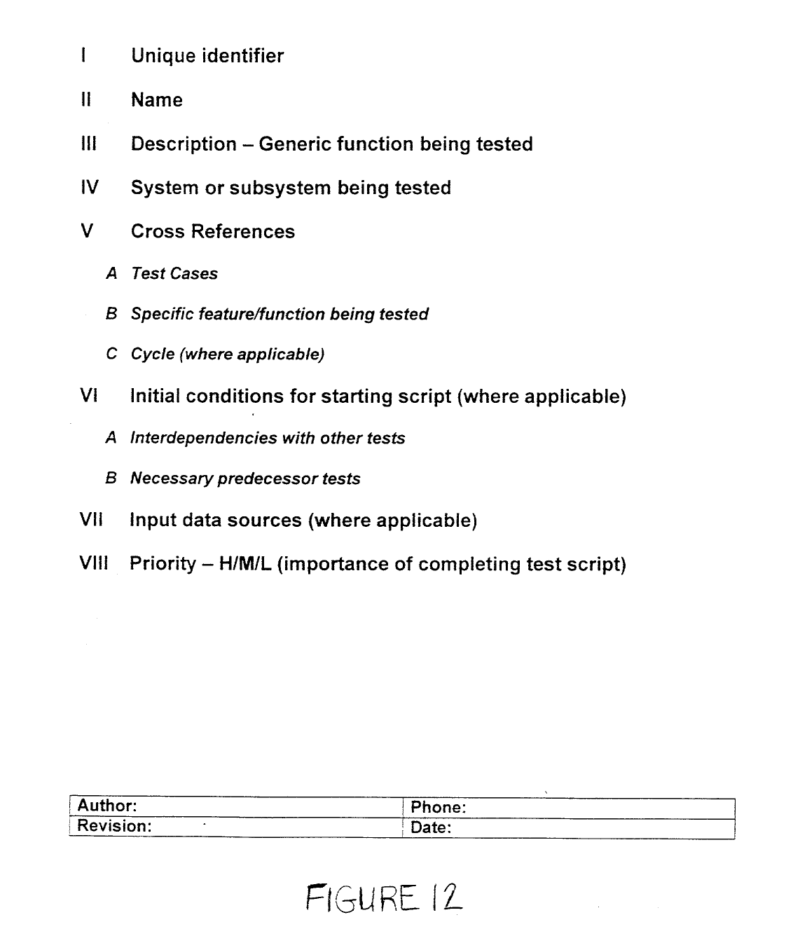

An illustrative example test script template, such as for generating a test script for conducting testing with respect to modification of a computer system, is shown in FIG. 12. There should be at least one test script for use in conducting testing of an implemented project pursuant to a RFS. The test script should include one or more cases, or illustrative scenarios, to use in testing whether the implemented project can function correctly in response to such scenarios. The test script should also set forth any initial conditions for starting the test script, any input data sources, as well as any necessary predecessor tests which should be conducted prior to execution of the test described in the test script. Additionally, the test script should specify a level of priority given to the test in the test script (e.g., high, medium or low level priority) wherein if a high level priority test is not conducted, the project may not be forwarded to the production environment.

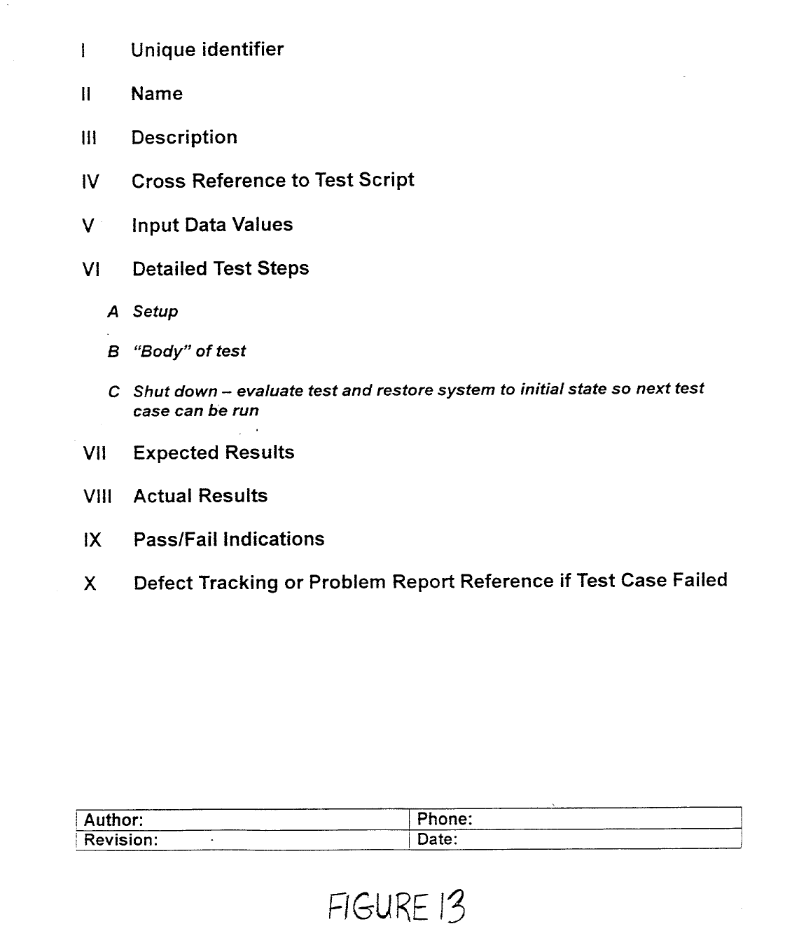

An illustrative example test case template, such as for generating a test case for conducting testing with respect to a modification of a computer system is shown, in FIG. 13. A test case is used to define specific test conditions for the general test conditions defined in the test script of FIG. 12. At least one test case should be included in each test script. The test case should cross-reference the test script with which it is associated. The test case should then set forth in detail the steps to be conducted in the test in question. It should also set forth any steps necessary to restore the project being tested to an initial condition following completion of the testing. The test case may also include a description of one or more expected results and a description of one or more actual results of the testing. The test case should also define any resultant conditions which indicate that the project “passed” the test or “failed” the test.

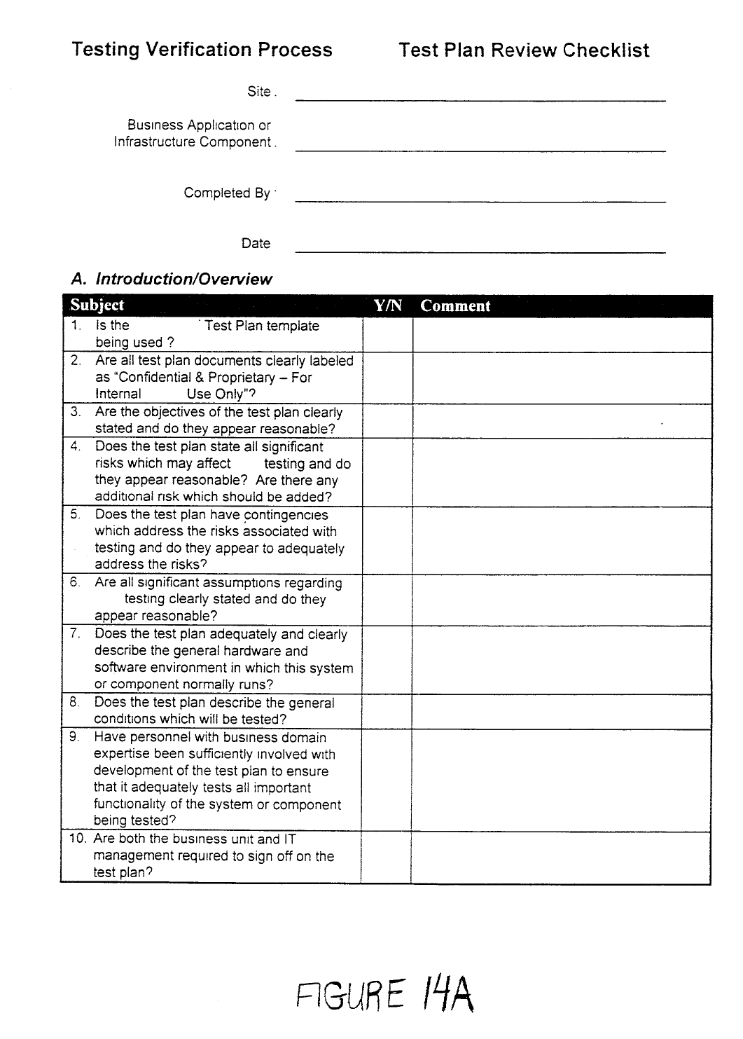

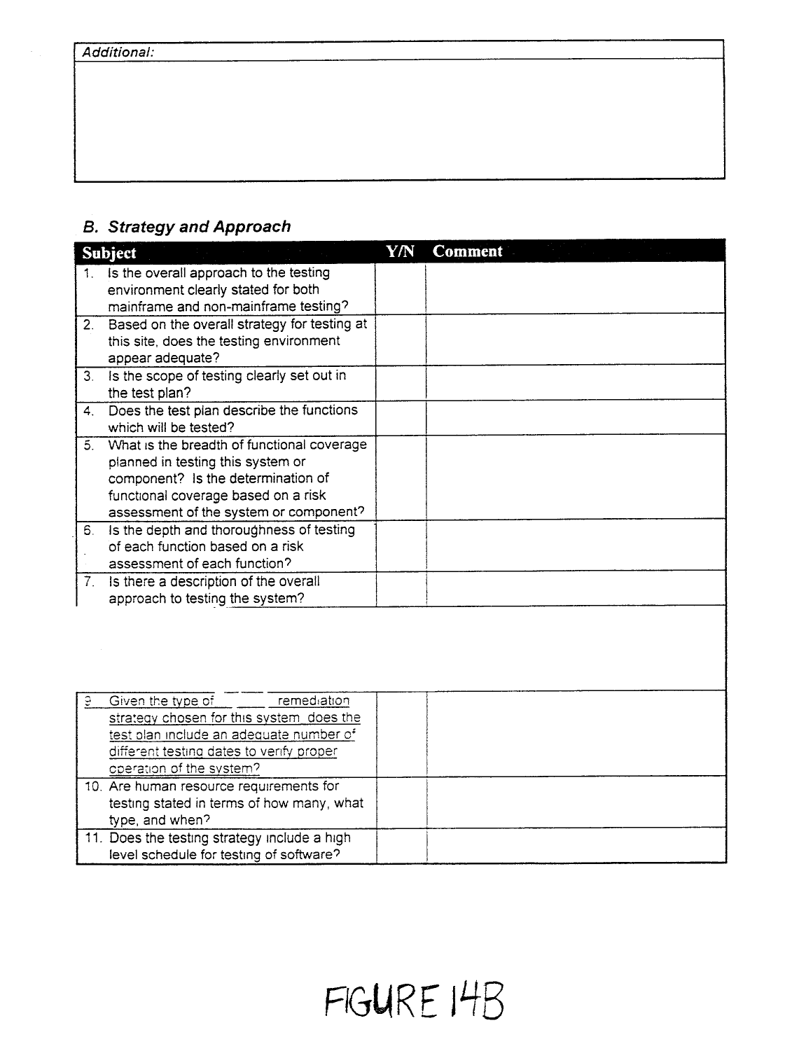

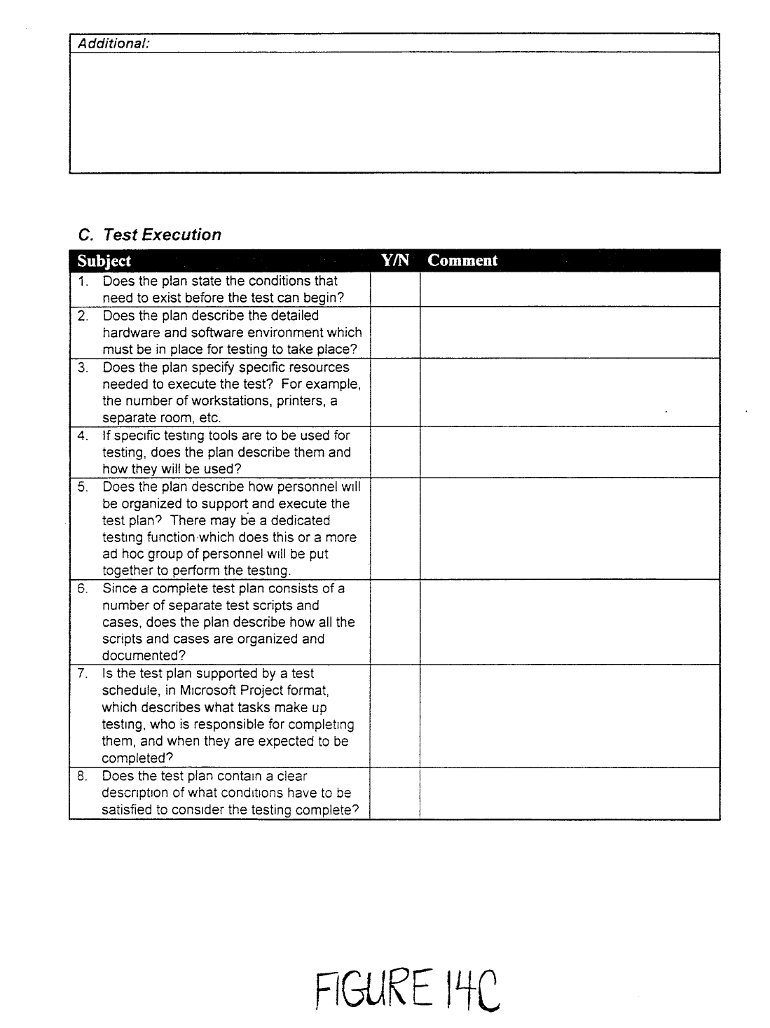

An illustrative example test plan review checklist is illustrated in FIGS. 14A through 14C. The test plan review checklist is used to document the work performed by the test plan review participants. A test plan review checklist 14 is to be completed by each test plan review participant as they are reviewing a test plan prior to the formal test plan review. The test plan review checklist may include a plurality of questions designed to verify that the test plan review documents have been properly prepared and include all necessary items of information. For example, a test plan review checklist may include questions such as “Does the test plan adequately and clearly describe the general hardware and software environment in which this system or component normally runs?”

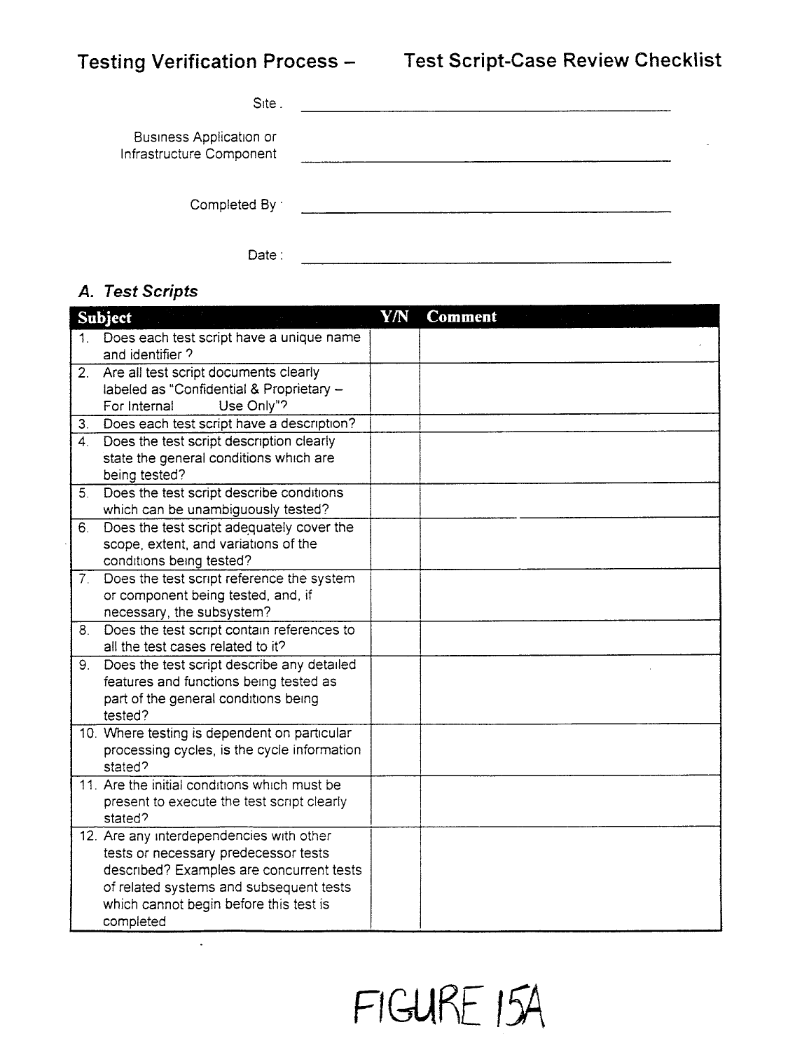

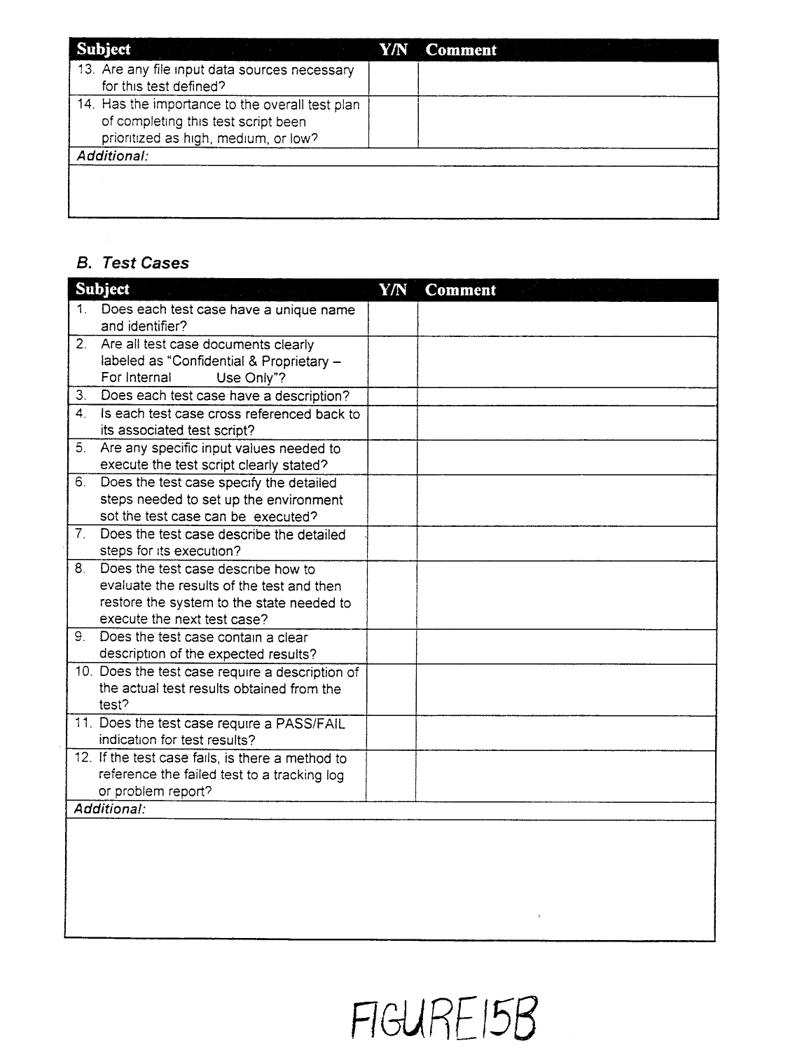

An illustrative example test script/case review checklist is illustrated in FIGS. 15A and 15B. The test script/case review checklist is similar to the test plan review checklist except that it is used to ensure that the test scripts and the test cases have been properly prepared and include all necessary items of information.

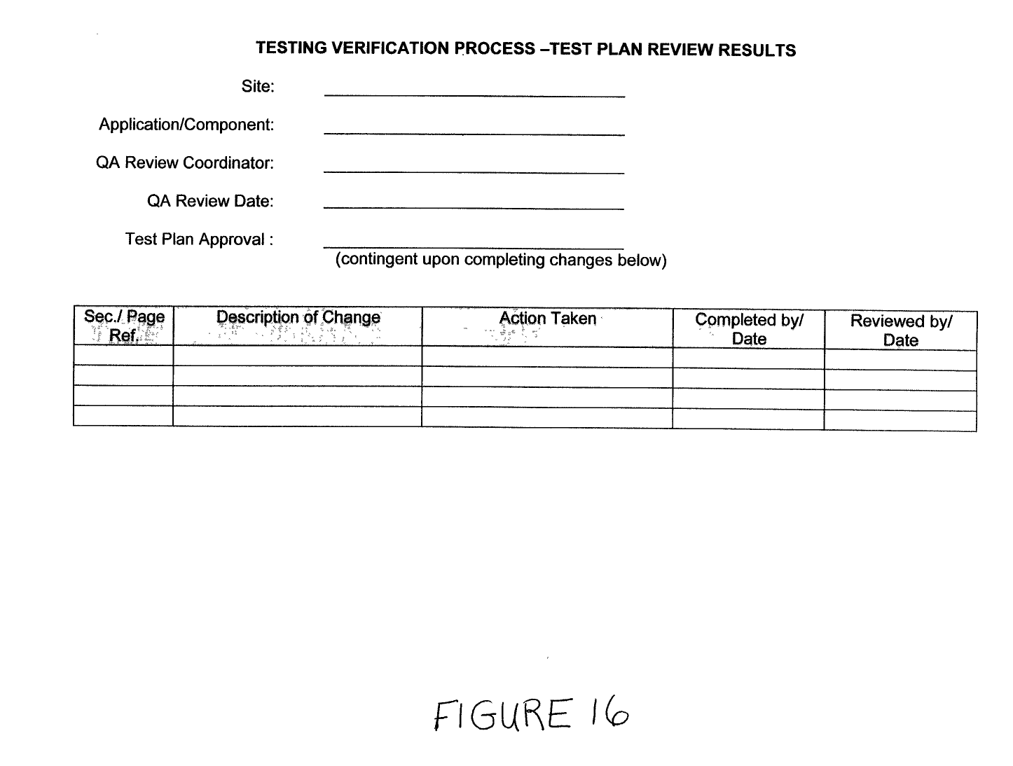

An illustrative example test plan review results form is illustrated in FIG. 16. The test plan review results form is used to document any recommended changes to the test plan agreed upon by the participants during the test plan review. The scribe is responsible for completing this test plan review results form and sending it to the test plan author for reference in updating and revising the test plan review documents after the completion of the test plan review, and to the facilitator for reference during review of the test plan changes.

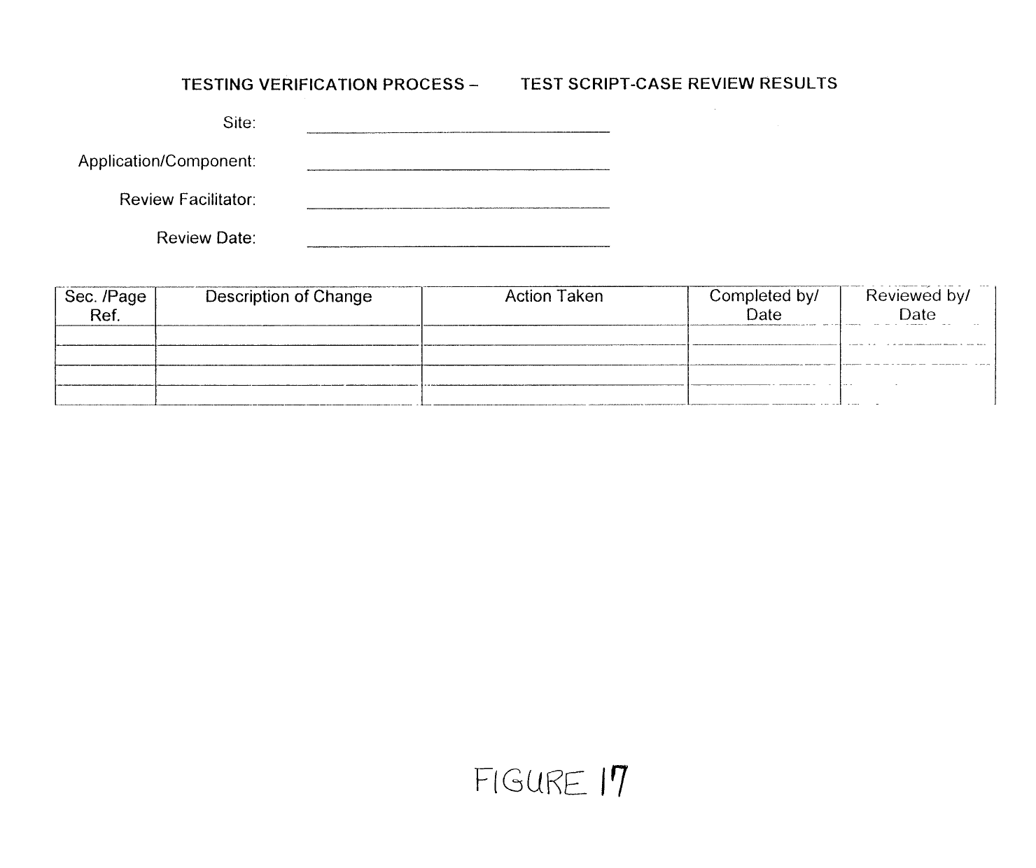

An illustrative example test script/case review results form is shown in FIG. 17. The test script/case review results form is handled exactly the same as the test plan review results form except it is used to document recommended changes to the test scripts and the test cases following the completion of the test plan review.

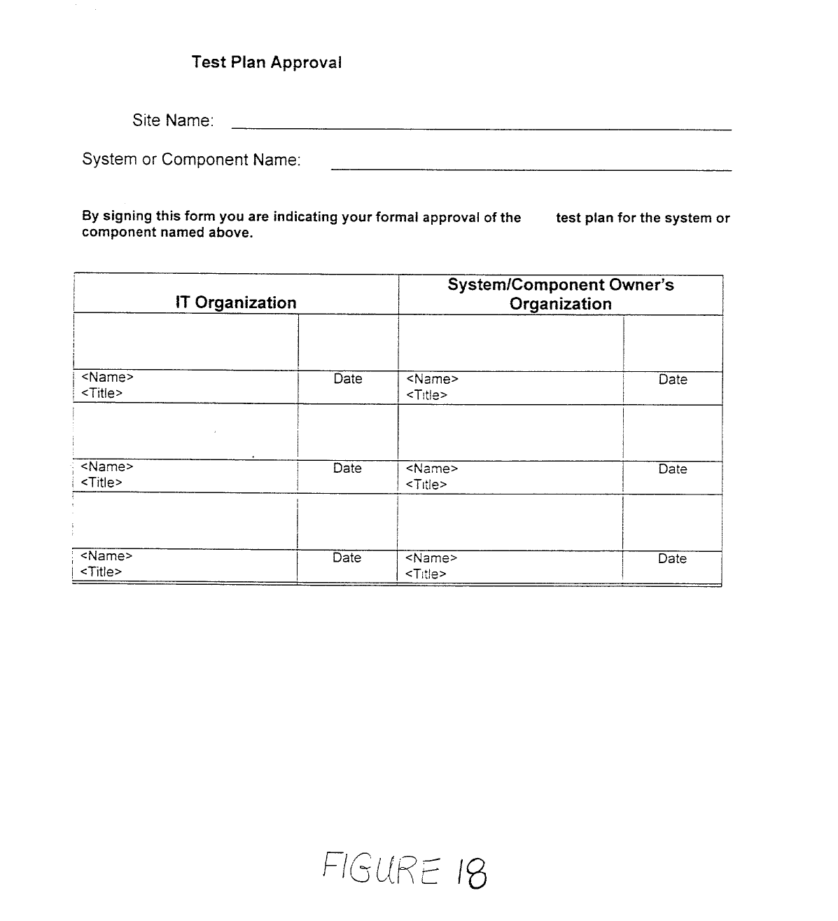

An illustrative example test plan approval form is illustrated in FIG. 18. The test plan approval form is used to document management approval of the test plan and its associated test scripts and test cases. The persons listed in the test plan as necessary for approval should be listed on the test plan approval form and they should each sign the test plan approval form to indicate their approval. The project leader is responsible for obtaining the approval signatures and then sending a copy of the completed test plan approval form to the model office.

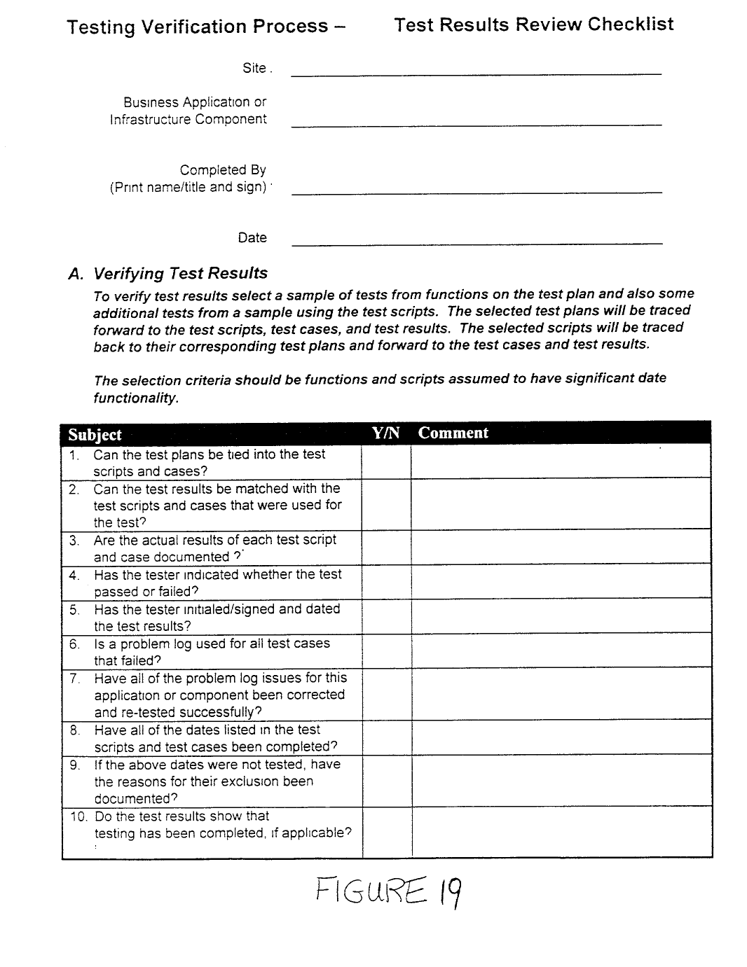

An illustrative example of a test plan review results checklist is illustrated in FIG. 19. The test plan review results checklist is used to verify the results of testing. The test plan review results checklist includes a plurality of questions designed to determine that all necessary testing was conducted and that the test plan review results form adequately documents the results of the testing conducted.

As is evident from the detailed description set forth above, the process for managing change of the present invention overcomes the deficiencies of prior processes by providing a process which can be used to manage any type of change in an organization whether product-related, service-related, or administrative or procedural in nature. The process is easily adapted to any of these changes.

It will be apparent to those skilled in the art that various modifications and variations can be made to the processes of the present invention without departing from the scope or spirit of the invention. Thus, it is intended that the present invention cover the modifications and variations of this invention provided they came within the scope of the appended claims and their equivalents.

What is claimed is:

1. A test plan review process for verifying a test plan for implementing a request for service, said test plan review process comprising the steps of:
a. preparing a plurality of test plan review documents;
b. scheduling a test plan review;
c. identifying and notifying each of a plurality of participants of the scheduled test plan review, wherein said participants include a facilitator, a test plan author, a technologist, a scribe and a user;
d. making the test plan review documents electronically available to the test plan review participants;
e. conducting the test plan review;
f. receiving any proposed changes to the test plan review documents resulting from the conducted test plan review;
g. recording the proposed changes to the test plan review documents on a test plan review results form;
h. sending the test plan review results form to the facilitator;
i. reviewing the test plan review results form with the test plan author;
j. incorporating the test plan review results from the test plan review results form in the test plan; and
k. filing the test plan review results form.

2. The test plan review process of claim 1, wherein the step of preparing the test plan review documents is conducted by the test plan author using a plurality of test plan document templates electronically available in a project public folder of a computer memory; and following the step of preparing the test plan review documents, the process further includes the step of sending the test plan review documents to a project leader at a site where the test plan review will take place.

3. The test plan review process of claim 1, wherein said facilitator reviews the test plan review documents before conducting the test plan review, and leads the conducting of the test plan review.

4. The test plan review process of claim 1, wherein said technologist is a person familiar with a technology that is the subject of the request for service.

5. The test plan review process of claim 1, wherein said scribe records the proposed changes to the test plan review documents on the test plan review results form and transmits the test plan review results form to the facilitator.

6. The test plan review process of claim 1, wherein a project leader is responsible for obtaining official approval of the test plan, scheduling the test plan review and ensuring that test plan review checklists are completed and executed.

7. The test plan review process of claim 1, wherein the user is a representative of a site where the test plan was written and is familiar with a business functionality of the request for service which is the subject of the test plan review.

8. A request for service (RFS) process comprising the steps of:
a. a work management team receiving a request for a service;
b. the work management team forwarding the request for a service to a team of developers;
c. the team of developers recommending at least one change and at least one task to implement the request for a service and forwarding the request for a service together with the recommended at least one change and the at least one task to a change management team;
d. the change management team migrating the request for a service from a development environment to a model office/testing environment;
e. a quality assurance team of a model office writing and implementing a test plan for testing a project which is a subject of the request for a service in the model office/testing environment;
f. if any problems or errors are found during the testing in the test region, the quality assurance team requesting a new task pursuant to a request for a service and forwarding the new task to the team of developers;
g. repeating steps (c) through (f) until there are no errors;
h. the quality assurance team of the model office forwarding the request for a service to the change management team upon successful completion of the testing in the test region and after obtaining business approval; and
i. the change management team implementing the request for a service in a production region.

9. The test plan review process of claim 8, wherein said request for a service includes a request for a new or a modified product, or a new or a modified process, or a new or a modified service, or a new or a modified software application, or a new or a modified hardware component.

10. A process for managing change comprising the steps of:
a. providing a request for a service (“RFS”);
b. analyzing the RFS by a team of developers;
c. proposing at least one change and at least one task to implement the RFS;
d. testing the proposed at least one change and the proposed at least one task according to a test plan in a test region prior to implementing the RFS in a production region;
e. verifying the testing; and
f. implementing the RFS in the production region.

11. The process of claim 10, wherein the step of proposing at least one change and at least one task includes the sub-steps of:
a. scheduling a test plan review;
b. preparing a plurality of test plan review documents;
c. identifying and notifying a plurality of participants of the scheduled test plan review, wherein said participants include a facilitator, a test plan author, a technologist, a scribe and a user;
d. making the test plan review documents electronically available to the test plan review participants, and
e. conducting the test plan review.

12. The test plan review process of claim 11, further including the steps of:
a. preparing the plurality of test plan review documents by the test plan author using a plurality of test plan document templates electronically available in at least one project public folder;
b. sending the test plan review documents to a project leader at a site where the test plan review will take place;
c. conducting the test plan review wherein the scribe records a plurality of events that occur during the test plan review, a plurality of results of the test plan review, and at least one proposed change to the test plan review documents based on the results of the test plan review;
d. receiving the at least one proposed change to the test plan review documents made during the test plan review;
e. recording the least one proposed change to the test plan review documents on a test plan review results form;
f. signing the test plan review results form;
g. sending the test plan review results form to the facilitator;
h. reviewing the test plan review results form with the test plan author;
i. incorporating the test plan review results from the test plan review results form in the test plan; and
j. filing the test plan review results form.

13. The test plan review process of claim 11, wherein said facilitator reviews the test plan review documents before conducting the test plan review, and leads the conduct of the test plan review.

14. The test plan review process of claim 11, wherein said technologist is a person familiar with a technology that is a subject of the request for service.

15. The test plan review process of claim 11, wherein said user is a representative of a site where the test plan was written and is familiar with a business functionality of the request for service which is the subject of the test plan review.

16. The test plan review process of claim 11, wherein a project leader is responsible for obtaining official approval of the test plan, scheduling the test plan review and ensuring that test plan review checklists are completed and executed.

17. The test plan review process of claim 11, wherein the scribe records the proposed changes to the test plan review documents on the test plan review results form and transmits the test plan review results form to the facilitator.

18. The test plan review process of claim 11, wherein the author prepares the plurality of test plan review documents using a plurality of test plan document templates electronically available in a project public folder of a computer memory.

19. A process for managing a request for service using a facility external to a business organization comprising the steps of:
a. a work management team internal to the business organization sending the request for service to a model office of the business organization;
b. an analyst in the model office transmitting the request for service to the external facility;
c. assigning an associate at the external facility to work on the request for service;
d. the associate at the external facility writing a test plan and a test script;
e. obtaining approval of the written test plan and the test script;
f. the associate executing the written test plan and the test script;
g. the associate conducting testing pursuant to the test plan and the test script;
h. the associate reporting any errors found during testing by writing a task;
i. sending the task to a change management team after the errors found during testing are corrected;
j. repeating steps (g) through (i) until there are no errors;
k. the associate obtaining approval for the request for service from the analyst in the model office;
l. conducting a test results review;
m. moving a project that is a subject of the request for service to a production region; and
n. closing the request for service.
